(19) United States
(12) Patent Application Publication
(10) Pub. No.: US 2024/0174074 A1
(43) Pub. Date: May 30, 2024

(54) Self-Powered Fan Wheel Cooling System for Electric Vehicles

(71) Applicant: Sun Way Shue, VALLEY SPRINGS, CA (US)

(72) Inventor: Sun Way Shue, VALLEY SPRINGS, CA (US)

(21) Appl. No.: 18/059,951

(22) Filed: Nov. 29, 2022

(51) Int. Cl. B60K 11/06; B60B 19/10; B60B 27/00

(52) U.S. Cl. CPC B60K 11/06; B60B 19/10; B60B 27/0047; B60K 2001/006

(57) ABSTRACT

An invention using vehicle wheels with fan blades as spokes to generate the airflow through the vehicle heat sources to optimize the cooling performance by its self-power.

### BACKGROUND OF THE INVENTION

### Field of Invention

The present invention relates to a cooling system for vehicle's heat sources.

The present invention refers to a heat dissipating design, which facilitates efficient cooling of electric vehicle batteries, fuel cell stacks, motors, converters, brakes and other heat source.

### Background

Energy efficiency and thermal performances are essential for vehicles' operation; therefore an energy saving, low cost plus high efficient cooling arrangement will be desirable for all kinds of vehicles such as electric vehicles, hybrid cars, and so on.

The present invention provides sufficient cooling function by its self-power. The vehicle's nature movement will generate airflow to dissipate the heat from heat sources.

### SUMMARY

The present invention provides major advantages listed below;
1. The present invention utilizes its self-power to perform the cooling functions.
2. The cooling functions sustain as long as the vehicle has movement.
3. The cooling capability is proportional to the vehicle's speed and to the vehicle's energy consumption as well generally.
4. The plurality of fans in series and in parallel combination optimizes the cooling capability for the vehicle.
5. The radiator fabricated with heat pipes provides cooling capability within the operating temperature range.

### BRIEF DESCRIPTIONS OF DRAWINGS

FIG. 1 3D conceptual embodiment of the present invention;

FIG. 2 Top sectional view of the embodiment shown in FIG. 1;

FIG. 3 Exploded view of the embodiment with number system shown in FIG. 1;

FIG. 4 Clockwise fan wheel with convex blade spokes 44, to intake airflow.

FIG. 5 Clockwise fan wheel with concave blade spokes 55, to exhaust airflow.

FIG. 6 Airflow directions in the embodiment while moving up.

FIG. 7 Conceptual structure of the battery modules with heat pipe radiator

FIG. 8 Airflow vs. Static Pressure of the fan wheel solutions

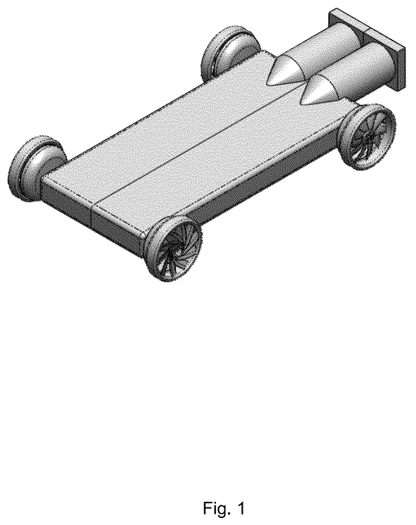

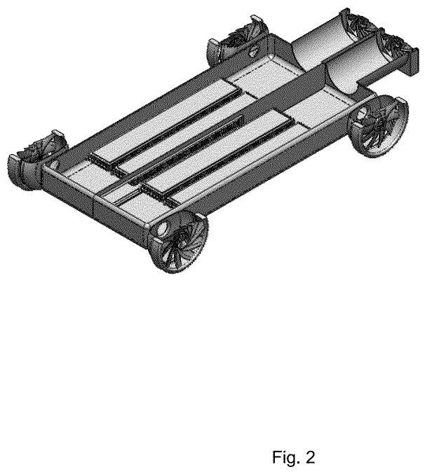

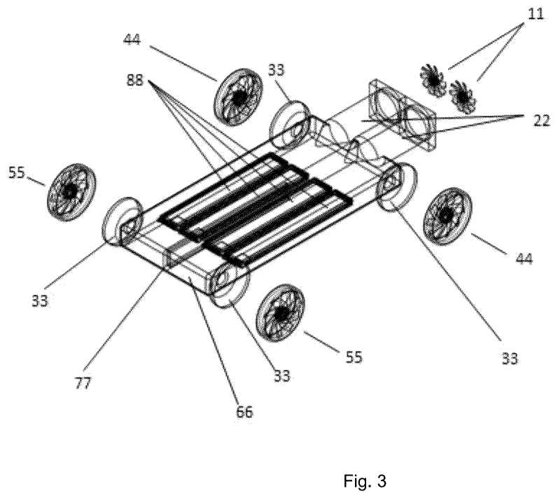

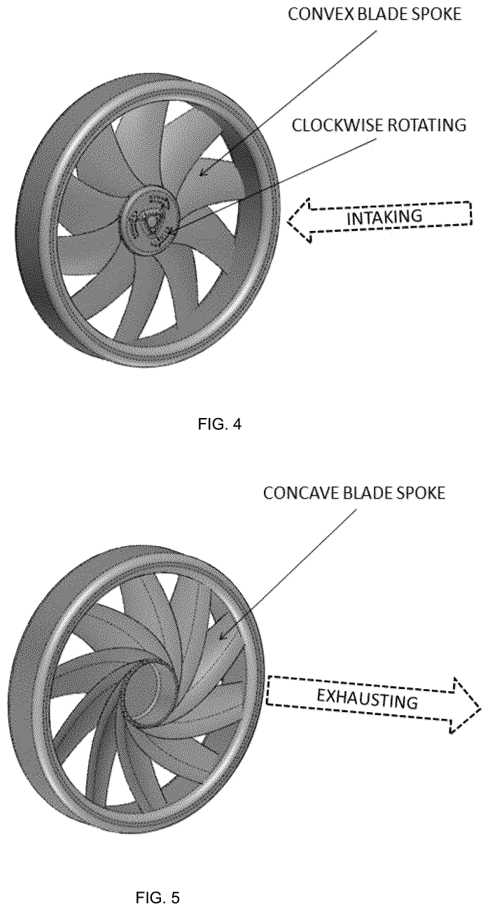

### DETAIL DESCRIPTIONS

The system of invention consists of key components listed as below:

The fan of radiator noted as 11, to circulate cooling air through the radiator

The heat pipe radiator noted as 22 and shown in FIG. 7, to absorb the heat from heat sources, wherein consists of a series of heat pipes (shown in FIG. 7) populated among high conductivity fins (shown in FIG. 7) and the primary heat source(s), e.g., battery modules 88 and others, to perform the cooling function by its own power.

The airflow cone noted as 33. with universal joint (no shown) to induce airflow through the air duct of the enclosure noted as 66.

The intake fan wheel noted as 44, connected to the drive shaft linked with power train of the vehicle to drive the airflow through the inlet cone 33, into the enclosure 66. The wheel is mounted with tire and inner spokes are structured with convex fan blades to propel in the airflow when wheel clockwise rotating.

The exhaust fan wheel noted as 55, connected to the drive shaft linked with power train of the vehicle to exhaust the airflow through the inlet cone 33, from the enclosure 66. The wheel is mounted with tire and inner spokes are structured with concave fan blades to expel away the warm airflow when wheel clockwise rotating.

The enclosure noted as 66, to embrace heat sources e.g., the battery modules 88, inverters etc. and to hold heat sources at desired positions for the airflow ventilating through.

The deflector noted as 77, to guide the airflow cooling the heat sources as desired.

The battery modules noted as 88, are connected with heat pipes and conductivity fins of radiator to cool off the operating temperature.

There is no active, dedicated power needed to perform the cooling process.

Once the vehicle is operating either forward or backward with speed, the radiators 22, the intake fan wheels 44 and the exhausted fan wheels 55 will generate cooling airflow through the enclosure 66. And the higher the speed, the more airflow the throughput according to Fan Law 1 tells that the change in airflow rate of a fan is proportional to the change in speed of the propeller as below:

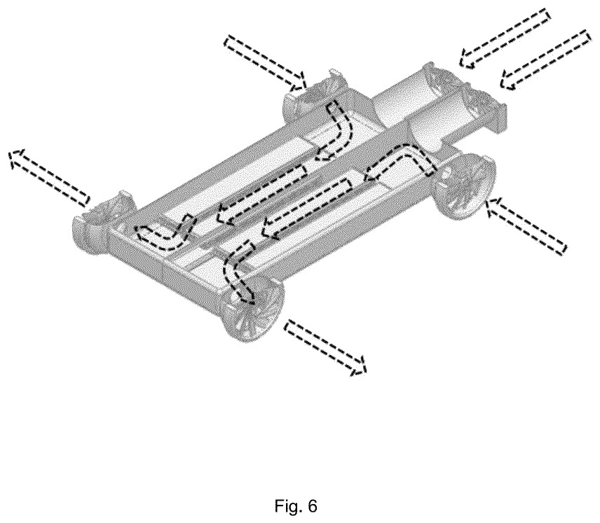

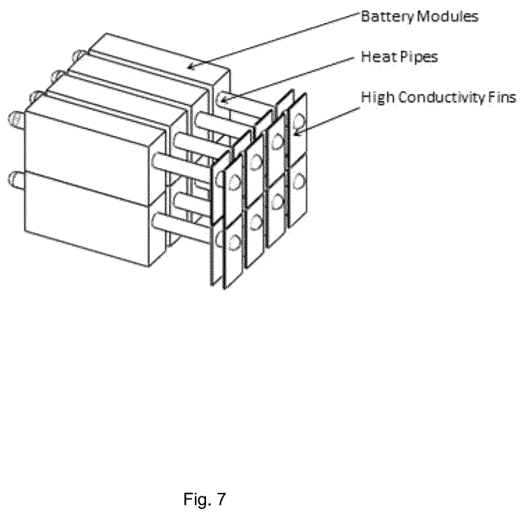

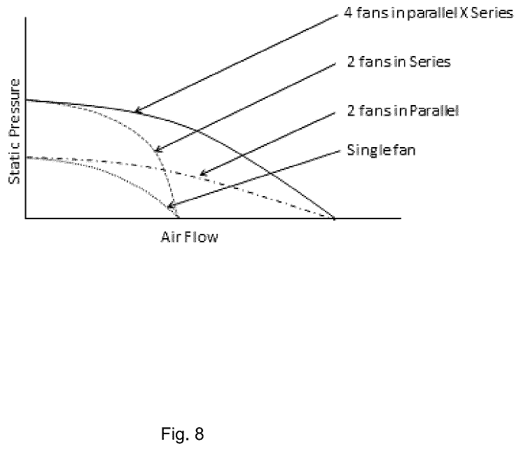

The invention system presents a parallel fan array with plural channels (shown as FIG. 6) and each channel contains multiple fans in series mechanism, which multiplies cooling capability (shown as FIG. 8) compared to traditional setting with a stand-alone radiator cooling arrangement.

What is claimed is:

1. A vehicle cooling system, comprising:
a plurality of wheels (44, 55) with fan blades as spokes;
a plurality of airflow cones(33) to induce airflow;
a plurality of radiators (22) populated with heat pipes and installed with fans (11) respectively;
an enclosure (66) mounted to a vehicle to hold heat sources like battery modules (88), fuel cell stacks, motor and brakes(not shown), etc.

2. A plurality of fan wheels (44, 55) according to claim 1, wherein applies a series arrangement to transport airflow to dissipate the heat from heat source.

3. A plurality of fans in series according to claim 2, applies a parallel arrangement to be a fan array (shown in FIG. 6) to multiply the cooling capability.

4. An enclosure (66) according claim 1, wherein integrates deflector(s) (77) that guides the cooling air through the ducts of enclosure (66) to improve cooling performance.

5. A plurality of radiators (22) according claim 1, wherein multiple heat pipes are populated among conductive fins and heat source(s), e.g., battery modules to extract and to transport heat.
